(19) United States
(12) Patent Application Publication
(10) Pub. No.: US 2005/0122896 A1
(43) Pub. Date: Jun. 9, 2005

(54) Apparatus and method for canceling interference signal in an orthogonal frequency division multiplexing system using multiple antennas

(75) Inventors: Kee-Bong Song, Chuncheon-si (KR); Chan-Soo Hwang, Yongin-si (KR); Dong-Jun Lee, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/985,515

(22) Filed: Nov. 10, 2004

(30) Foreign Application Priority Data
Nov. 12, 2003 (KR) 79760/2003

(51) Int. Cl. H04J 11/00; H04Q 7/00

(52) U.S. Cl. 370/210; 370/334

(57) ABSTRACT

In an encoding apparatus in a mobile communication system using a plurality of antennas, a puncturer punctures input coded bits in an RCP (Rate-Compatible Puncturing) method, a distributor divides the punctured coded bits by the number of the antennas depending on how many bits are punctured, an interleaver interleaves the divided coded bits, a modulator modulates the interleaved coded bits, and an arranger prioritizes the modulated symbols, arranges the modulated symbols according to priority levels, and transmits the arranged symbols through the antennas.

### PRIORITY

This application claims priority under 35 U.S.C. § 119 to an application entitled “Apparatus and Method for Canceling Interference Signal in an Orthogonal Frequency Division Multiplexing System Using Multiple Antennas” filed in the Korean Intellectual Property Office on Nov. 12, 2003 and assigned Serial No. 2003-79760, the contents of which are incorporated herein by reference.

### BACKGROUND OF THE INVENTION

1. Field of the Invention

The present invention relates generally to a MIMO (Multi-Input Multi-Output) OFDM (Orthogonal Frequency Division Multiplexing) mobile communication system, and in particular, to an apparatus and method for improving the performance of an error correction code for correcting errors resulting from the effects of error propagation.

2. Description of the Related Art

A signal transmitted on a radio signal experiences multipath interference due to a variety of obstacles between a transmitter and a receiver. The characteristics of the multipath radio channel are determined by a maximum delay spread and signal transmission period. If the transmission period is longer than the maximum delay spread, no interference occurs between successive signals and the radio channel is characterized in the frequency domain as a frequency non-selective fading channel. However, the transmission period is shorter than the maximum delay spread at wideband high-speed transmission. As a result, interference occurs between successive signals and a received signal is subject to intersymbol interference (ISI). The radio channel is characterized in the frequency domain as a frequency selective fading channel. In the case of single carrier transmission using coherent modulation, an equalizer is required to cancel the ISI. Also, as data rate increases, ISI-incurred distortion increases and the complexity of the equalizer in turn increases. To solve the equalization problem in the single carrier transmission scheme, OFDM was proposed.

In general, OFDM is defined as a two-dimensional access scheme of time division access and frequency division access in combination. An OFDM symbol is distributedly transmitted over sub-carriers in a predetermined number of subchannels.

In OFDM, the spectrums of subchannels orthogonally overlap with each other, having a positive effect on spectral efficiency. Also, implementation of OFDM modulation/demodulation by IFFT (Inverse Fast Fourier Transform) and FFT (Fast Fourier Transform) allows efficient digital realization of a modulator/demodulator. OFDM is robust against frequency selective fading or narrow band interference, which renders OFDM effective as a transmission scheme for European digital broadcasting and for high-speed data transmission adopted as the standards of large-volume wireless communication systems such as IEEE 802.11a, IEEE 802.16a and IEEE 802.16b.

OFDM is a special case of MCM (Multi-Carrier Modulation) in which an input serial symbol sequence is converted to parallel symbol sequences and modulated to multiple orthogonal sub-carriers, prior to transmission.

The first MCM systems appeared in the late 1950's for military high frequency (HF) radio communication, and OFDM with overlapping orthogonal sub-carriers was initially developed in the 1970's. In view of orthogonal modulation between multiple carriers, OFDM has limitations in actual implementation for systems. In 1971, Weinstein, et. al. proposed an OFDM scheme that applies DFT (Discrete Fourier Transform) to parallel data transmission as an efficient modulation/demodulation process, which was a driving force behind the development of OFDM. Also, the introduction of a guard interval and a cyclic prefix as the guard interval further mitigates adverse effects of multi-path propagation and delay spread on systems. As a result, OFDM has widely been exploited for digital data communications such as digital audio broadcasting (DAB), digital TV broadcasting, wireless local area network (WLAN), and wireless asynchronous transfer mode (WATM). Although hardware complexity was an obstacle to the wide use of OFDM, recent advances in digital signal processing technology including FFT and IFFT enable OFDM to be implemented. OFDM, similar to FDM (Frequency Division Multiplexing), boasts of optimum transmission efficiency in high-speed data transmission because it transmits data on sub-carriers, maintaining orthogonality among them. The optimum transmission efficiency is further attributed to good frequency use leading to efficiency and robustness against multipath fading in OFDM. In particular, overlapping frequency spectrums lead to efficient frequency use and robustness against frequency selective fading and multipath fading. OFDM reduces the effects of ISI by use of guard intervals and facilitates the design of a simple equalizer hardware structure. Furthermore, since OFDM is robust against impulse noise, it is increasingly popular in communication systems.

FIG. 1 is a block diagram of a typical OFDM mobile communication system. Referring to FIG. 1, an encoder 100 encodes binary input bits and outputs coded bit streams. An interleaver 102 interleaves the serial coded bit streams and a modulator 104 maps the interleaved bit streams to symbols on a symbol mapping constellation. QPSK (Quadrature Phase Shift Keying), 8PSK (8ary Phase Shift Keying), 16QAM (16ary Quadrature Amplitude Modulation) or 64QAM (64ary QAM) has been adopted as a modulation scheme in the modulator 104. The number of bits in one symbol is determined in correspondence with the modulation scheme used. A QPSK modulation symbol includes 2 bits, an 8PSK modulation symbol 3 bits, a 16QAM modulation symbol 4 bits, and a 64QAM modulation scheme 6 bits. An IFFT processor 106 IFFT-processes the modulated symbols and transmits the IFFT signal through a transmit antenna 108.

A receive antenna 110 receives the symbols from the transmit antenna 108. An FFT processor 112 FFT-processes the received signal and a demodulator 114, having the same symbol mapping constellation as used in the modulator 104, converts despread symbols to binary symbols in a demodulation scheme. The demodulation scheme is determined in correspondence with the modulation scheme. A deinterleaver 116 deinterleaves the demodulated binary bit streams in a deinterleaving method corresponding to the interleaving method of the interleaver 102. A decoder 118 decodes the interleaved binary bit streams.

FIG. 2 is a block diagram of an OFDM mobile communication system using multiple transmit/receive antennas for data transmission/reception. Referring to FIG. 2, an encoder 200 encodes binary input bits and outputs a coded bit stream. A serial-to-parallel (S/P) converter 202 converts the serial coded bit stream into parallel coded bit streams. The parallel bit streams are provided to interleavers 204 to 206. The interleavers 204 to 206, modulators 208 to 210, IFFTs 212 to 214, and transmit antennas 216 to 218 operate in the same manner as their respective counterparts 102, 104, 106 and 108 illustrated in FIG. 1, except that due to the use of multiple transmit antennas, the number of sub-carriers assigned to each IFFT is less than the number of sub-carriers assigned to the IFFT 106 illustrated in FIG. 1.

Receive antennas 220 to 222 receive symbols from the transmit antennas 216 to 218. FFTs 224 to 226 FFT-process the received signal and output FFT signals to a successive interference cancellation (SIC) receiver 228. The operation of the SIC receiver 228 will be described with reference to FIG. 3. The output of the SIC receiver 228 is applied to a de-orderer 230. The SIC receiver 228 first detects a stream in a good reception state and then detects another stream using the detected stream. Because the SIC receiver 228 determines which stream is in a better reception state, a detection order is different from the order of transmitted signals. Therefore, the de-orderer 230 de-orders the transmitted signals according to their reception states. Demodulators 232 to 234 and deinterleavers 236 to 238 process the de-ordered symbols in the same manner as the demodulator 114 and the deinterleaver 116 illustrated in FIG. 1. A parallel-to-serial (P/S) converter 240 converts the parallel deinterleaved bit streams to a serial binary bit stream, which will be described with reference to FIG. 4. A decoder 242 decodes the binary bit stream.

Signals transmitted from the different transmit antennas are received linearly overlapped at the receive antennas in the multiple antenna system. Hence, as the number of the transmit/receive antennas increases, the complexity of estimating the transmitted signal for decoding increases. The SIC receiver uses low-computation linear receivers repeatedly to reduce the decoding complexity. The SIC receiver achieves gradually improved performance by canceling interference in a previous decoded signal. Yet, the SIC scheme has a distinctive shortcoming in that errors generated in the previous determined signal are increased in the current stage. Referring to FIG. 3, the structure of the SIC receiver will be described. The SIC receiver receives signals through two receive antennas by way of example. In FIG. 3, the signals received through the two receive antennas are y₁ and y₂, as set forth in Equation (1):
y₁=x₁h₁₁+x₂h₁₂+z₁
y₁=x₁h₂₁+x₂h₂₂+z₂ (1)

As noted from Equation (1), two transmit antennas transmit signals. In Equation (1), x₁ and x₂ are signals transmitted from first and second transmit antennas, respectively, h₁₁ and h₁₂ are a channel coefficient between the first transmit antenna and a first receive antenna and a channel coefficient between the second transmit antenna and the first receive antenna, respectively, h₂₁ and h₂₂ are a channel coefficient between the first transmit antenna and a second receive antenna and a channel coefficient between the second transmit antenna and the second receive antenna, respectively, and z₁ and z₂ are noise on radio channels.

An MMSE (Minimum Mean Square Error) receiver 300 estimates x₁ and x₂ from y₁ and y₂. As described earlier, the SIC receiver 228 estimates the signals transmitted from the transmit antennas in a plurality of stages. The SIC receiver first estimates a signal transmitted from one transmit antenna (the first transmit antenna) and then a signal transmitted from the other transmit antenna (the second transmit antenna) using the estimated signal. In the case of three transmit antennas, the SIC receiver further estimates a signal transmitted from a third transmit antenna using the estimates of the transmitted signals from the first and second transmit antennas. The signals received at the MMSE receiver from the first and second receive antennas are shown in Equation (2):
y₁=x₁h₁₁+z₃
y₂=x₁h₂₁+z₄ (2)

As noted from Equation (2), the MMSE receiver 300 estimates the signal transmitted from the second antenna as noise. By Equation (1) and Equation (2), Equation (3) is derived as follows:
z₃=x₂h₁₂+z₁
z₄=x₂h₂₂+z₂ (3)

While the transmitted signal from the second transmit antenna is estimated as noise and then the transmitted signal from the first transmit antenna is estimated in Equation (2), the transmitted signal from the first transmit antenna can be estimated as noise, instead and then the transmitted signal from the second transmit antenna can be transmitted. In this case, as shown in Equation (4),
y₁=x₂h₁₂+z₆
y₂=x₂h₂₂+z₆ (4)

The MMSE receiver 300 estimates the transmitted signal x₁ using Equation (2) according to Equation (5):
E=|Ay−x₁|² (5)
where y is the sum of y₁ and y₂. Using Equation (5), x₁ having a minimum E is achieved. Therefore, the estimate \tilde{x}₁ of x₁ is calculated by according to Equation (6):
\tilde{x}₁=A_{y} (6)
In the same manner, x₂ can be estimated. A stream orderer 302 prioritizes the estimates of x₁ and x₂ according to their MMSE values. That is, it determines a received signal having minimum errors on a radio channel based on the MMSE values. In the case illustrated in FIG. 3, x₁ has less errors than x₂.

The stream orderer 302 provides \tilde{x}₁ to the de-orderer illustrated in FIG. 2 and a decider 304. The decider 304 decides the values of the estimated bits. Because the MMSE receiver 300 estimates the transmitted signals simply based on mathematical calculation, the estimates may be values that cannot be available for transmission. Therefore, the decider 304 decides an available value for transmission in the transmitter using the received estimate, and outputs the value to an inserter 306. If no errors occur on the radio channel, the estimate is identical to the decided value. The inserter 306 provides the decided \tilde{x}₁ to calculators 308 and 310. The calculators 308 and 310 estimate the received signals y₁ and y₂ according to Equation (7):
\overline{y}₁=\hat{x}₁h₁₁+x₂h₁₂+z₁
\overline{y}₂=\hat{x}₁h₂₁+x₂h₂₂+z₂ (7)

An MMSE receiver 312 estimates the signal transmitted from the second transmit antenna using the estimated received signals according to Equation (8):
E=|B\overline{y}−x₂|² (8)
where \tilde{y} is the sum of \tilde{y}₁ and \tilde{y}₂. By Equation (8), x₂ resulting in a minimum E is achieved. Thus, an estimate \tilde{x}₂ of x₂ is calculated according to Equation (9):
\overline{x}₂=B\overline{y} (9)
and x₂ is provided to the de-orderer 203 illustrated in FIG. 2.

As described above, the SIC receiver 228 estimates the transmitted signal from the second transmit antenna using the estimate of the transmitted signal from the first transmit antenna.

Since the transmitted signal from the second transmit antenna uses the estimate of the transmitted signal from the first transmit antenna, the estimate of the transmitted signal from the first transmit antenna is reflected in a received signal used to estimate the transmitted signal from the second transmit antenna. An estimate of the received signal by which to estimate the transmitted signal from the second transmit antenna is expressed as Equation (10):
y′(j)=y′(j−1)−h(j−1)x′(j−i), y′(1)=y (10)
where y′(j) is an estimate of a received signal used to estimate a transmitted signal from a j^{th} transmit antenna, y′(j−1) is an estimate of a received signal used to estimate a transmitted signal from a (j−1)^{th} transmit antenna, and x′(j−i) is an estimate of the transmitted signal from the (j−1)^{th} transmit antenna. Equation (10) shows that the estimate of a received signal used for estimation of a transmitted signal from the previous transmit antenna is to be considered to estimate a transmitted signal from the current antenna. The following Equation (11) represents a scaling factor to remove the bias of the estimate of the transmitted signal from the j^{th} transmit antenna.

$$c ( j ) = {[ 1 - \frac{1}{SNR} {( H ( j ) * H ( j ) + \frac{{I}_{{N}_{T}}}{SNR} )}^{- 1} ]}^{- 1}$$

where H(j) is a channel coefficient between the j^{th} transmit antenna and the multiple transmit antennas and I_{N}_{ᵣ} is an N_{T}xN_{T} identity matrix. Using Equation (10) and Equation (11), a signal transmitted from a particular transmit antennas is estimated according to Equation (12):

$${x}^{′} ( j ) = {c ( j ) [ \text{(} H ( j ) * H ( j ) + \frac{{I}_{{N}_{T}}}{SNR} ]}^{- 1} h ( j ) * {y}^{′} ( j ) \qquad ( 12 )$$

As noted from Equation (12), a signal transmitted from the (j−1)^{th} transmit antenna must be first estimated in order to estimate a signal transmitted from the j^{th} transmit antenna. Therefore, if errors are involved in estimating the transmitted signal from the (j−1)^{th} transmit antenna, the transmitted signal from the j^{th} transmit antenna has errors. This is attributed to the nature of the SIC receiver. Accordingly, there is a need for a method of solving this problem.

### SUMMARY OF THE INVENTION

An object of the present invention is to substantially solve at least the above problems and/or disadvantages and to provide at least the advantages below. Accordingly, an object of the present invention is to provide, in a system that uses information detected in a previous stage, detects information in a current stage, an apparatus and method for reducing the effect of errors in the previous detected information on the detection of the information in the current stage.

Another object of the present invention is to provide an apparatus and method for transmitting each data on a different radio channel according to the significance of the data and prioritizing received data for channel estimation according to the significance of the received data.

The above objects are achieved by providing an encoding and decoding apparatus and an encoding and decoding method in a mobile communication system using multiple antennas.

According to one aspect of the present invention, in an encoding apparatus in a mobile communication system using a plurality of antennas, a puncturer punctures input coded bits in an RCP (Rate-Compatible Puncturing) method, a distributor divides the punctured coded bits by the number of antennas depending on how many bits are punctured, an interleaver interleaves the divided coded bits, a modulator modulates the interleaved coded bits, and an arranger prioritizes the modulated symbols, arranges the modulated symbols according to priority levels, and transmits the arranged symbols through the antennas.

According to another aspect of the present invention, in a decoding apparatus in a mobile communication system using a plurality of antennas, an FFT converts a frequency-domain signal, which is received at the antennas via sub-carriers on a radio channel, to a time-domain signal, an SIC receiver channel-estimates a lower-priority symbol using a channel estimate value of a higher-priority symbol among the FFT symbols, and a combiner combines the channel-estimated symbols.

According to a further aspect of the present invention, in an encoding method in a mobile communication system using a plurality of antennas, input coded bits are punctured in an RCP (Rate-Compatible Puncturing) method, and divided by the number of antennas depending on how many bits are punctured, interleaved, and modulated. The modulated symbols are prioritized and arranged according to priority levels. The arranged symbols are transmitted through the antennas.

According to still another aspect of the present invention, in a decoding method in a mobile communication system using a plurality of antennas, a frequency-domain signal, which is received at the antennas via sub-carriers on a radio channel, is fast-Fourier-transformed to a time-domain signal. A lower-priority symbol is channel-estimated using a channel estimate value of a higher-priority symbol among the FFT symbols and the channel-estimated symbols are combined.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a typical OFDM mobile communication system;

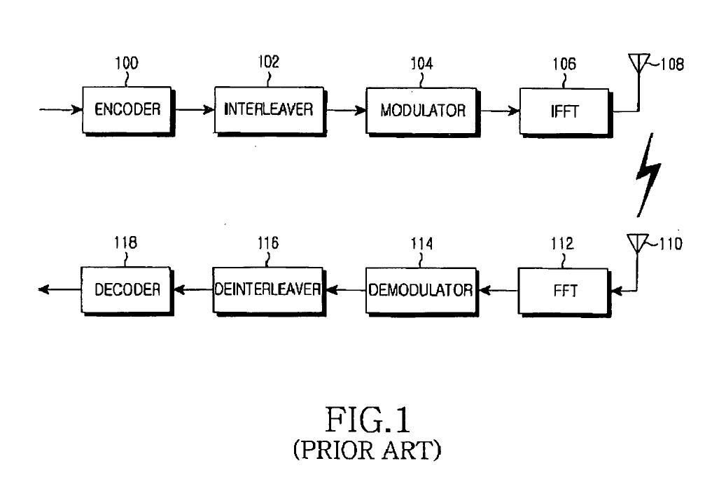

FIG. 2 is a block diagram of a typical multiple antenna OFDM mobile communication system;

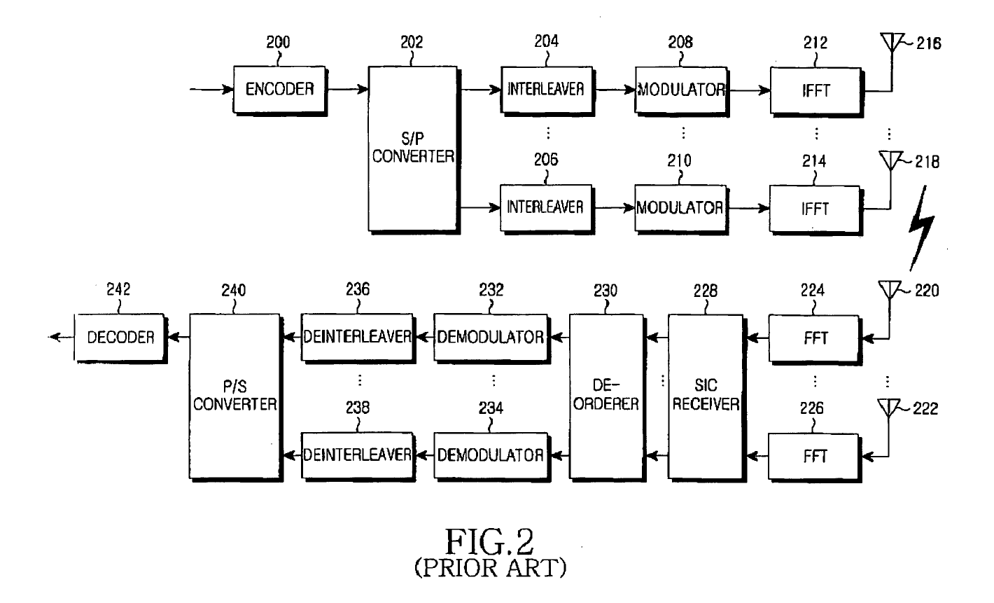

FIG. 3 is a block diagram of an SIC receiver illustrated in FIG. 2;

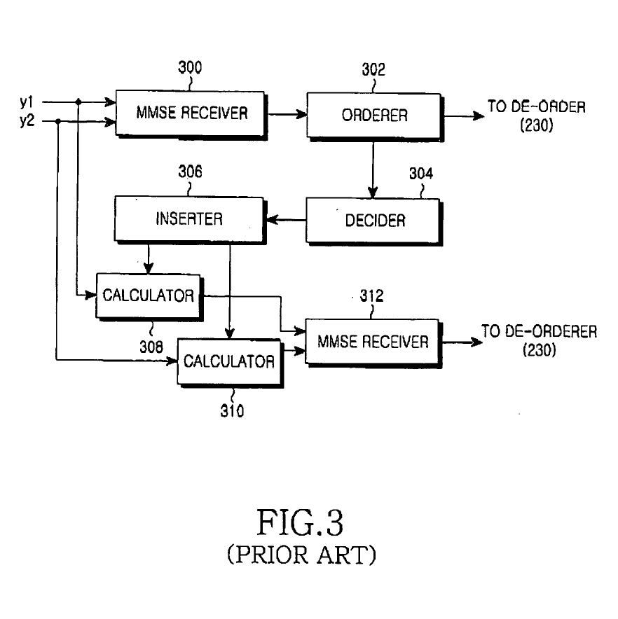

FIG. 4 is a block diagram of a transmitter in a multiple antenna OFDM mobile communication system according to the present invention;

FIG. 5 is a block diagram of the receiver in the multiple antenna OFDM mobile communication system according to the present invention;

FIG. 6 is a block diagram of the RCP-SIC receiver according to the present invention;

FIG. 7 is a graph comparing the prevent invention with a conventional method; and

FIG. 8 is another graph comparing the prevent invention with the conventional method.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

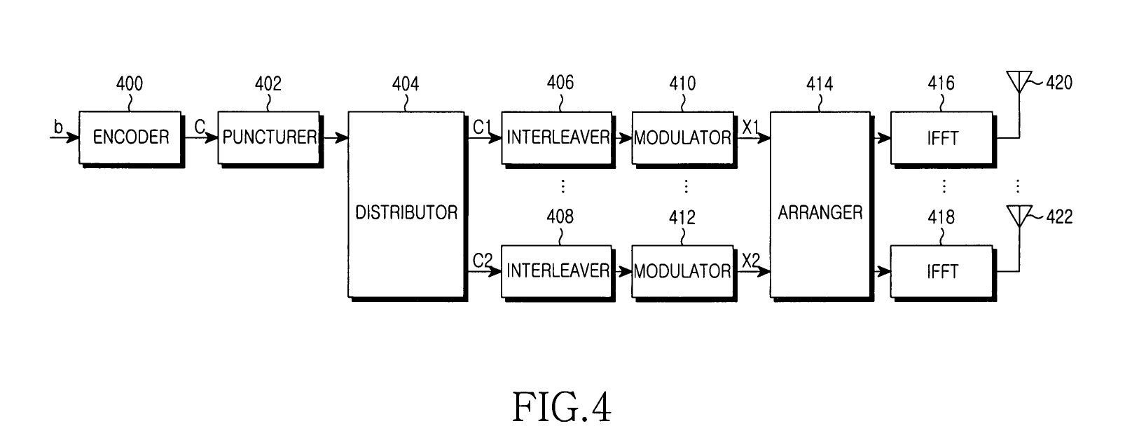

FIG. 4 is a block diagram of a transmitter in a multiple antenna OFDM mobile communication system according to the present invention. Referring to FIG. 4, an encoder 400 encodes input bits and outputs a coded bit stream. At a coding rate of ⅓, the encoder 400 outputs a 3-bit stream for the input of one bit. This operation can be represented as Equation (13):

$$[ \begin{matrix}1 & 1 & 1 & 1 & 1 & 1 & 1 & 1\end{matrix} ] -> [ \begin{matrix}1 & 1 & 1 & 1 & 1 & 1 & 1 & 1 \\ 1 & 1 & 1 & 1 & 1 & 1 & 1 & 1 \\ 1 & 1 & 1 & 1 & 1 & 1 & 1 & 1\end{matrix} ] \qquad ( 13 )$$

where “1” denotes a non-punctured coded bit (i.e. a binary bit having a value of 0 or 1). According to Equation (13), the encoder 400 generates a 24-bit stream for the input of 8 binary bits. A puncturer 402 punctures the coded bit stream, maintaining its free distance. Thus, the puncturer 402 uses an RCP (Rate-Compatible Puncturing) method. RCP refers to a method of transmitting bits through antennas, each antenna having a different coding rate. An example of RCP is shown in Equation (14):

$$[ \begin{matrix}1 & 1 & 1 & 1 & 1 & 1 & 1 & 1 \\ 1 & 1 & 1 & 1 & 1 & 1 & 1 & 1 \\ 1 & 1 & 1 & 1 & 1 & 1 & 1 & 1\end{matrix} ] -> [ \begin{matrix}1 & 1 & 1 & 1 & 1 & 1 & 1 & 1 \\ 1 & 1 & 1 & 1 & 1 & 1 & 1 & 1 \\ 0 & 0 & 0 & 0 & 0 & 0 & 0 & 0\end{matrix} ] -> [ \begin{matrix}1 & 1 & 1 & 1 & 1 & 1 & 1 & 1 \\ 1 & 0 & 1 & 0 & 1 & 0 & 1 & 0 \\ 0 & 0 & 0 & 0 & 0 & 0 & 0 & 0\end{matrix} ] \qquad ( 14 )$$

where “1” denotes a non-punctured bit and “0” denotes a punctured bit. The first matrix in Equation (14) is the input of the puncturer 402. The second and third matrices demonstrate puncturing of some bits in the first matrix. Yet, the three matrices have the same free distance. For the puncturing pattern of the second matrix, an actual coding rate is ½. For the puncturing pattern of the third matrix, an actual coding rate is ⅔. While the coding rate of ⅔ can be achieved directly from the first matrix, it is done in two stages for the sake of convenience. The actual coding rate by the RCP is shown in Equation (15):

$$R = \frac{L}{L + M} , M = L , 2 L , 3 L , … , ( N - 1 ) L \qquad ( 15 )$$

where R denotes a coding rate after puncturing, L is the number of input bits to the encoder, N is a mother coding rate of the encoder, and M is a random number. Hence, according to Equation (13) and Equation (14), the actual coding rates after the puncturing are ½ and ⅔, as calculated by Equation (15). If M is set to (N/2−1)L, puncturing is performed in the puncturing pattern of the third matrix. Therefore, the puncturer 402 punctures the input binary bit stream in the pattern of the third matrix.

A distributor 404 distributes the punctured binary bit stream to interleavers 406 to 408 according to the puncturing pattern. That is, it provides a non-punctured bit stream and a punctured bit stream to different interleavers. Referring to Equation (14), given two interleavers, the entire first row and the first half of the second row, “111111111010” is provided to a first interleaver and the last half of the second row and the entire third row, “101000000000” is provided to a second interleaver. Given three interleavers, the bit stream in the first row is provided to a first interleaver, the bit stream in the second row to a second interleaver, and the bit stream in the third row to a third interleaver. The transmitter illustrated in FIG. 4 transmits the punctured bit stream and the non-punctured bit stream together. Preferably, the puncturer 402 and the distributor 404 are incorporated into one component.

The interleavers 406 to 408 interleave the input streams. Modulators 410 to 412 map the interleaved code symbols on a symbol mapping constellation in QPSK, 8PSK, 16QAM or 64QAM. The number of bits in one modulation symbol is determined in correspondence with the modulation scheme used. A QPSK modulation symbol includes 2 bits, an 8PSK modulation symbol 3 bits, a 64QAM modulation symbol 4 bits, and a 16QAM modulation scheme 6 bits.

An arranger 414 prioritizes transmit antennas 420 to 422 according to signals transmitted through them. As the signal for a transmit antenna is less punctured, a higher priority level is given to the transmit antenna. A receiver first estimates a signal from a higher-priority transmit antenna. If the distributor 404 distributes the non-punctured bit stream to the interleaver 406 and the punctured bit stream to the interleaver 408, the arranger 414 prioritizes the modulation symbols received from the modulator 410. IFFTs 416 to 418 IFFT-process the prioritized symbols and transmit the IFFT signals through the transmit antennas 420 to 422.

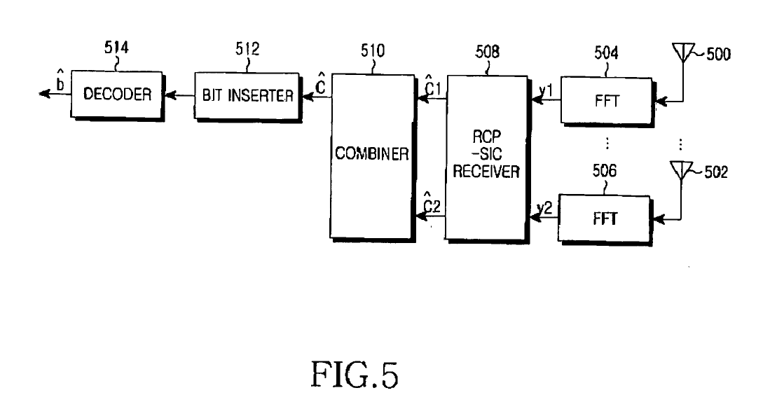

FIG. 5 is a block diagram of a receiver according to the present invention. Receive antennas 500 to 502 receive symbols from the transmit antennas. FFTs 504 to 506 FFT-process the received symbols. An RCP-SIC receiver 508 SIC-processes the FFT signals, which will be described later in detail. A combiner 510 combines the signals received from the RCP-SIC receiver 508 in the reverse operation to the operation of the distributor illustrated in FIG. 4. A bit inserter 512 inserts bits of a predetermined value in the combined bit stream. The combiner 510 and the bit inserter 512 may be incorporated into a single component. A decoder 514 decodes the binary bit stream received from the bit inserter 512 and outputs the resulting binary bits.

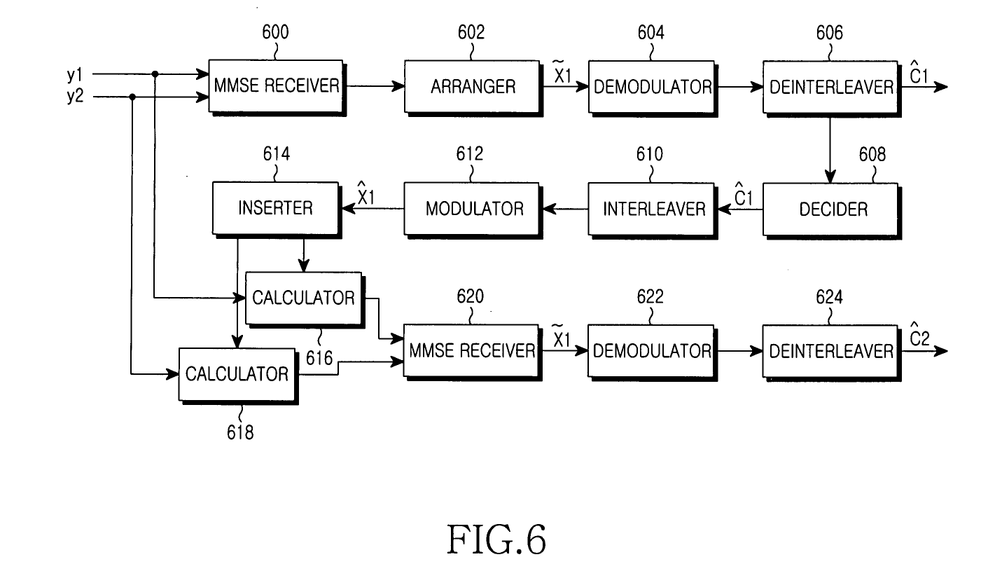

FIG. 6 is a block diagram of the RCP-SIC receiver according to the present invention. The RCP-SIC receiver of FIG. 6 operates for two transmit antennas and two receive antennas, by way of example.

Referring to FIG. 6, an MMSE receiver 600 receives FFT signals y₁ and y₂ defined as Equation (1) and detects an MMSE using y₁ and y₂. The MMSE receiver 600 considers the signal from the second transmit antenna as noise as illustrated in Equation (2), or the signal from the first transmit antenna as noise as illustrated in Equation (4). In the former case, the MMSE receiver 600 estimates x₁ that satisfies the MMSE by Equation (5). In the latter case, the MMSE receiver 600 estimates x₂ that satisfies the MMSE by Equation (5). The estimated x₁ and x₂ are provided to an arranger 602. The arranger 602 detects priority levels set by the transmitter. The priority levels are dependent on puncturing or non-puncturing. If x₁ (the signal from the first transmit antenna) is higher in priority than x₂ (the signal from the second transmit antenna), the arranger 602 transmits the estimate of x₁ to a demodulator 604. If x₂ is higher in priority than x₁, the arranger 602 transmits the estimate of x₂ to demodulator 604. In the case illustrated in FIG. 6, the former case is assumed.

The demodulator 604 demodulates the estimate of x₁. A deinterleaver 606 deinterleaves the demodulated x₁. Through demodulation and deinterleaving, symbols are converted to a bit stream. The bit stream is provided to a decider 608 and the combiner 510 illustrated in FIG. 5. The decider 608 decides the values of the deinterleaved bits. The estimated value in the MMSE receiver 600 may not be available for transmission because it is calculated simply mathematically. For example, if a transmit antenna transmits “1”, the MMSE receiver 600 may estimate the value as “1.12”, a value not transmittable from the transmit antenna. Therefore, the decider 608 decides the value transmittable from the transmit antenna using the estimate. If the radio channel is error-free, the estimate is identical to the decision value. While the estimate and the decision value are identical in the illustrated case of FIG. 6, they are different in most cases in reality.

An interleaver 610 interleaves the binary bit stream decided by the decider 608 and a modulator 612 modulates the interleaved bits. The modulation symbol of x₁ is inserted to an inserter 614. As described above, the RCP-SIC receiver estimates x₁ more accurately by use of the demodulator 604, the deinterleaver 606, the decider 608, the interleaver 610, and the modulator 612.

The inserter 614 provides the modulation symbol of x₁ to calculators 616 and 618. The calculators 616 and 618 estimate y₁ and y₂ using the modulation symbol of x₁ by Equation (10). An MMSE receiver 620 estimates x₂ using the estimates of y₁ and y₂ and the modulation symbol of x₁ in the same manner as x₁ estimation. The estimate of x₂ is converted to a binary bit stream through a demodulator 622 and a deinterleaver 624.

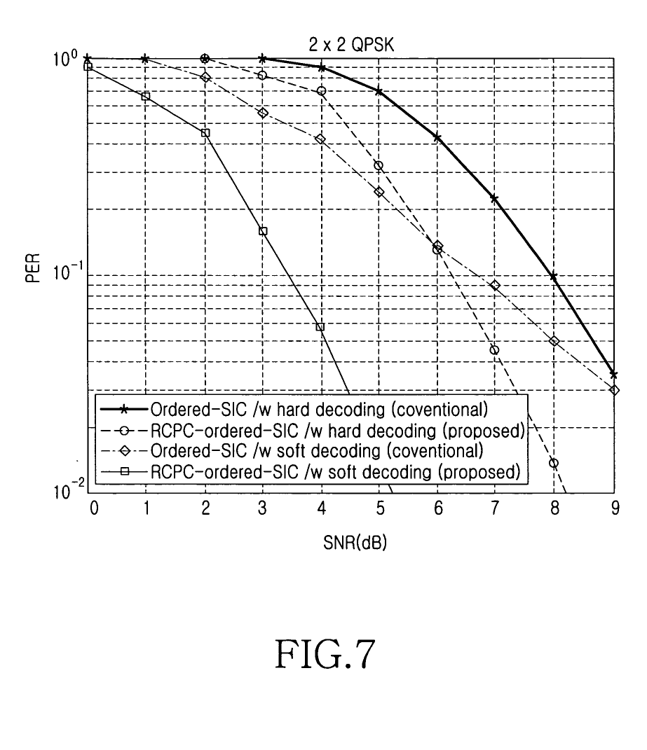

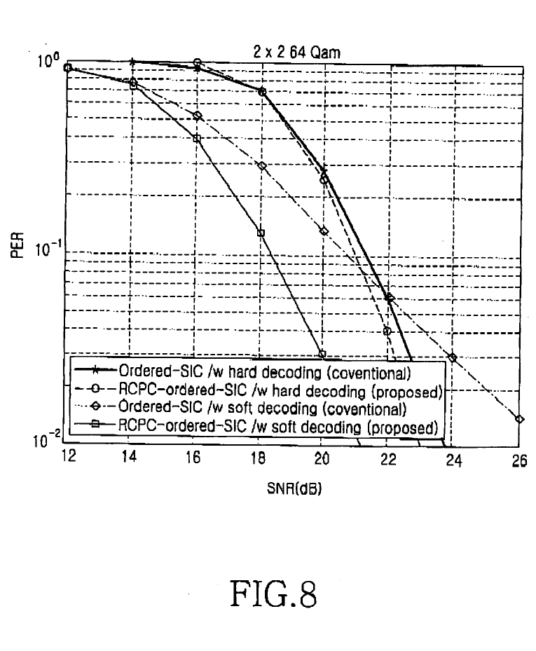

FIGS. 7 and 8 illustrate the effects of the present invention. Specifically, FIG. 7 illustrates the effects of the present invention in the case where QPSK modulation symbols transmitted through two transmit antennas are received through two receive antennas and FIG. 8 illustrates the effects of the present invention in the case where 64QAM modulation symbols transmitted through two transmit antennas are received through two receive antennas. The graphs illustrated in FIGS. 7 and 8 demonstrate that the present invention offers much better performance than the conventional method.

In accordance with the present invention as described above, a transmitter transmits each data on a different radio channel according to its priority and a receiver first recovers a higher-priority data, thereby overcoming the problem of fading-caused error performance degradation. That is, the receiver first recovers a higher-priority data (data having a lower error probability) and then another data using the recovered data. Thus, reception errors can be reduced.

While the invention has been shown and described with reference to a certain preferred embodiment thereof, it will be understood by those skilled in the art that various changes in form and details may be made therein without departing from the spirit and scope of the invention as defined by the appended claims.

1. An encoding apparatus in a mobile communication system using a plurality of antennas, comprising:
a puncturer for puncturing input coded bits in an RCP (Rate-Compatible Puncturing) method;
a distributor for dividing the punctured coded bits by the number of antennas depending on how many bits are punctured;
an interleaver for interleaving the divided coded bits;
a modulator for modulating the interleaved coded bits;
an arranger for prioritizing the modulated symbols, arranging the modulated symbols according to priority levels, and transmitting the arranged symbols through the antennas.

2. The encoding apparatus of claim 1, wherein the arranger gives a higher priority level to a less punctured modulation symbol.

3. The encoding apparatus of claim 1, further comprising an inverse fast Fourier transformer (IFFT) for converting the modulated symbols to a frequency-domain signal, for transmission via sub-carriers on a radio channel.

4. The encoding apparatus of claim 3, wherein the puncturer punctures a different number of bits according to a coding rate.

5. A decoding apparatus in a mobile communication system using a plurality of antennas, comprising:
a fast Fourier transformer (FFT) for converting a frequency-domain signal, which is received at the antennas via sub-carriers on a radio channel, to a time-domain signal;
a successive interference cancellation (SIC) receiver for channel-estimating a lower-priority symbol using a channel estimate value of a higher-priority symbol among the FFT symbols; and
a combiner for combining the channel-estimated symbols.

6. The decoding apparatus of claim 5, wherein the SIC receiver comprises:
an arranger for determining priority levels of received symbols;
a demodulator for demodulating the higher-priority symbol into coded bits;
a deinterleaver for deinterleaving the demodulated coded bits; and
a decider for deciding transmitted bits using the deinterleaved coded bits.

7. The decoding apparatus of claim 6, wherein the SIC receiver further comprises:
an interleaver for interleaving the decided transmitted bits of the higher-priority symbol;
a modulator for modulating the interleaved coded bits; and
a minimum mean square error (MMSE) receiver for channel-estimating the lower-priority symbol using the modulated coded bits of the higher-priority symbol.

8. An encoding method in a mobile communication system using a plurality of antennas, comprising the steps of:
puncturing input coded bits in an RCP (Rate-Compatible Puncturing) method;
dividing the punctured coded bits by the number of antennas depending on how many bits are punctured;
interleaving the divided coded bits;
modulating the interleaved coded bits;
prioritizing the modulated symbols and arranging the modulated symbols according to priority levels; and
transmitting the arranged symbols through the antennas.

9. The encoding method of claim 8, wherein the prioritizing step comprises the step of giving a higher priority level to a less punctured modulation symbol.

10. The encoding method of claim 8, further comprising the step of inverse-fast-Fourier-transforming the modulated symbols to a frequency-domain signal, for transmission via sub-carriers on a radio channel.

11. The encoding method of claim 10, wherein the puncturing step comprises the step of puncturing a different number of bits according to a coding rate.

12. A decoding method in a mobile communication system using a plurality of antennas, comprising the steps of:
fast-Fourier-transforming a frequency-domain signal, which is received at the antennas via sub-carriers on a radio channel, to a time-domain signal;
channel-estimating a lower-priority symbol using a channel estimate value of a higher-priority symbol among the FFT symbols; and
combining the channel-estimated symbols.

13. The decoding method of claim 12, wherein the channel estimation step comprises the steps of:
determining priority levels of received symbols;
demodulating the higher-priority symbol into coded bits;
deinterleaving the demodulated coded bits; and
deciding transmitted bits using the deinterleaved coded bits.

14. The decoding method of claim 13, wherein the channel estimation step further comprises the steps of:
interleaving the decided transmitted bits of the higher-priority symbol;
modulating the interleaved coded bits; and
channel-estimating the lower-priority symbol using the modulated coded bits of the higher-priority symbol.
